(19) United States
(12) Patent Application Publication
(10) Pub. No.: US 2024/0157347 A1
(43) Pub. Date: May 16, 2024

(54) MOVING BED LIGNOCELLULOSIC BIOMASS CONVERSION WITH FLUID BED CATALYST REGENERATION

(71) Applicant: CHEVRON U.S.A. INC., San Ramon, CA (US)

(72) Inventor: Sven Ivar HOMMELTOFT, Pleasant Hill, CA (US)

(21) Appl. No.: 18/054,281

(22) Filed: Nov. 10, 2022

(51) Int. Cl. B01J 23/92; B01D 15/18; B01J 21/04; C08H 8/00

(52) U.S. Cl. CPC B01J 23/92; B01D 15/1828; B01J 21/04; C08H 8/00; B01D 2215/027; B01J 2523/23; B01J 2523/31

(57) ABSTRACT

A process is provided for producing reduced acid lignocellulosic-derived bio-oil. treating a lignocellulosic biomass feedstock in a moving bed reactor with a metal oxide catalyst on an oxide support under treating conditions to produce a treated stream; directing spent metal oxide catalyst from the moving bed reactor to a fluidized bed regenerator, the spent metal oxide catalyst resulting from treating the lignocellulosic biomass feedstock with the metal oxide catalyst; regenerating the spent metal oxide catalyst in the fluidized bed regenerator by removing coke from the spent metal oxide catalyst in a combustion process that regenerates the spent metal oxide catalyst into the metal oxide catalyst; and returning to the moving bed reactor the metal oxide catalyst that has been regenerated in the fluidized bed regenerator. The obtained bio-oil is particularly suitable as a renewable feedstock for hydroprocessing in biofuel manufacture.

### FIELD

This disclosure relates generally to upgrading lignocellulosic biomass to reduced acid pyrolysis oil that may be used as renewable feedstocks for refinery processing and regeneration of catalysts used in such upgrading.

### BACKGROUND

Environmental concerns over fossil fuel greenhouse gas (GHG) emissions have led to an increasing emphasis on renewable energy sources. Wood and other forms of biomass including agricultural and forestry residues are examples of some of the main types of renewable feedstocks being considered for the production of liquid fuels. Energy from biomass based on energy crops such as short rotation forestry, for example, can contribute significantly towards reducing GHG emissions.

Fast pyrolysis is a thermal process during which solid biomass feedstock containing lignocellulosic material, i.e., plant and algae matter including dedicated energy crops, wood waste, and agricultural waste, is rapidly heated to pyrolysis temperatures of about 300° C. to about 900° C. in the absence of air using a pyrolysis reactor. Under these conditions, solid and gaseous pyrolysis products are formed. A vapor portion of the gaseous pyrolysis products can be condensed into biomass-derived pyrolysis oil (“bio-oil”).

Biomass-derived pyrolysis oil can serve as a potential feedstock in the production of biofuels in petroleum refineries or in stand-alone process units. However, biomass-derived pyrolysis oil is a complex, highly oxygenated organic liquid having properties that currently limit its utilization as a fuel. For example, conventional biomass-derived pyrolysis oil has high acidity (with a low pH and high total acid number) making it corrosive to storage, pipes, and downstream equipment. Conventional biomass-derived pyrolysis oil typically has a pH of less than 3 and a total acid number greater than 150. Further, conventional biomass-derived pyrolysis oil has low energy density and susceptibility to increased viscosity over time. The high acidity and low energy density of the biomass-derived pyrolysis oil is attributable in large part to oxygenated hydrocarbons in the oil, particularly carboxylic acids such as formic acid, acetic acid, etc. The oxygenated hydrocarbons in the oil are derived from oxygenated hydrocarbons in the gaseous pyrolysis products produced during pyrolysis.

To convert conventional biomass-derived pyrolysis oil into usable fuel for power or heat generation, or for transportation uses, further processing is required to reduce its acidity (as measured by an increase in pH). Often, this processing results in phase instability of the biomass-derived pyrolysis oil. Also, the processing can be quite costly, including high costs for hydrogen used in acidity reduction.

Accordingly, it is desirable to provide processes for converting lignocellulosic material into pyrolysis oil having reduced acidity. It is also desirable to produce lignocellulosic-derived pyrolysis oils having reduced acidity and increased energy density.

### SUMMARY

In one aspect, there is provided a process comprising: treating a lignocellulosic biomass feedstock in a moving bed reactor with a metal oxide catalyst on an oxide support under treating conditions to produce a treated stream, wherein the treating conditions in the moving bed reactor include a temperature in a range of from 400° C. to 600° C., a pressure in a range from 100 kPa to 10 MPa, and a weight hourly space velocity in a range from 0.1 to 10 kg lignocellulosic biomass per kg metal oxide catalyst per hour; directing spent metal oxide catalyst from the moving bed reactor to a fluidized bed regenerator, the spent metal oxide catalyst resulting from treating the lignocellulosic biomass feedstock with the metal oxide catalyst; regenerating the spent metal oxide catalyst in the fluidized bed regenerator by removing coke from the spent metal oxide catalyst in a combustion process that regenerates the spent metal oxide catalyst into the metal oxide catalyst; and returning to the moving bed reactor the metal oxide catalyst that has been regenerated in the fluidized bed regenerator.

### BRIEF DESCRIPTION OF THE DRAWINGS

FIG. 1 illustrates components of a reactor system in accordance with an example embodiment of the disclosure.

FIG. 2 illustrates a method for processing a lipid feedstock in accordance with an example embodiment of the disclosure.

### DETAILED DESCRIPTION

### Definitions

The term “lignocellulosic biomass” means any material containing cellulose and lignin. Lignocellulosic biomass may also contain hemicellulose.

The term “bio-oil” means a liquid product produced from biomass by a thermochemical process. Bio-oil may include bio-derived hydrocarbon fractions and oxygenated hydrocarbons such as carboxylic acids, alcohols, aldehydes, ketones, etc.

The term “pyrolysis” refers to the thermal decomposition of organic materials in an oxygen-lean atmosphere (i.e., significantly less oxygen than required for complete combustion).

The term “hydroprocessing” generally encompasses all processes in which a hydrocarbon feedstock is reacted with hydrogen in the presence of a catalyst and under hydroprocessing conditions, typically, at elevated temperature and elevated pressure. Hydroprocessing includes, but is not limited to, processes such as hydrogenation, hydrodeoxygenation, hydrodesulfurization, hydrodenitrogenation, hydrodemetallization, hydrodearomatization, hydroisomerization, hydrodewaxing, hydrocracking and mild hydrocracking.

The term “transportation fuels” refer here to fractions or cuts or blends of hydrocarbons having distillation curves standardized for fuels, such as for diesel fuel (middle distillate from 160° C. to 380° C., according to EN 590), gasoline (40° C. to 210° C., according to EN 228), aviation fuel (160° C. to 300° C., according to ASTM D1655 jet fuel), kerosene, naphtha, etc. Liquid fuels are hydrocarbons having distillation curves standardized for fuels, such as transportation fuels.

Various exemplary embodiments contemplated herein are directed to a process for producing reduced acid pyrolysis oils from lignocellulosic material. It should be appreciated that while the oil produced according to the exemplary embodiments may be generally described herein as a “reduced acid” bio-oil, this term generally includes any oil produced having a lower acidity than a pyrolysis oil conventionally produced from the same feedstock. The reduced acid bio-oil has higher energy density than conventional lignocellulosic-derived pyrolysis oil. “Higher energy density” as used herein means that the reduced acid lignocellulosic-derived pyrolysis oil has an increased heat of combustion as compared to conventional lignocellulosic-derived pyrolysis oil. An increased heat of combustion increases the suitability of the oil as fuel and biofuel.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation unless so indicated by the context and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a”, “an”, and “the” are intended to include plural alternatives, e.g., at least one. The terms “including”, “with”, and “having”, as used herein, are defined as comprising (i.e., open language), unless specified otherwise.

When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about”, it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

For any figure shown and described herein, one or more of the components may be omitted, added, repeated, and/or substituted. Additionally, it should be understood that in certain cases components of the example systems can be combined or can be separated into subcomponents. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

Lignocellulosic Biomass

The lignocellulosic biomass can be any type of biomass comprising lignin and cellulose such as non-woody plant biomass, agricultural wastes and forestry residues and sugar-processing residues. For example, the cellulosic feedstock can include grasses, such as switch grass, cord grass, rye grass, miscanthus, mixed prairie grasses, or a combination thereof; sugar-processing residues such as sugar cane bagasse and sugar beet pulp; agricultural wastes such as soybean stover, corn fiber from grain processing, corn stover, oat straw, rice straw, rice hulls, barley straw, corn cobs, wheat straw, canola straw, oat hulls, and corn fiber; and forestry wastes, such as recycled wood pulp fiber, sawdust, hardwood, softwood, or any combination thereof. Further, the lignocellulosic biomass may comprise lignocellulosic waste or forestry waste materials such as paper sludge, newsprint, cardboard and the like. Lignocellulosic biomass may comprise one species of fiber or, alternatively, a lignocellulosic biomass feedstock may comprise a mixture of fibers that originate from different lignocellulosic materials.

Typically, the lignocellulosic material will comprise cellulose in an amount greater than 2%, 5% or 10% and preferably greater than 20% (w/w). The lignocellulosic material can be of higher cellulose content, for example at least 30% (w/w), 35% (w/w), 40% (w/w) or more. Therefore, the lignocellulosic material may comprise from 2% to 90% (w/w), or from 20% to 80% (w/w) cellulose, or from 25% to 70% (w/w) cellulose, or 35% to 70% (w/w) cellulose, or more, or any amount therebetween.

Typically, the lignin content in lignocellulosic biomass is higher than 5% (w/w), such as from 15% to 40% (w/w).

Prior to pyrolysis of the lignocellulosic biomass, the lignocellulosic biomass is preferably preconditioned so as to enhance pyrolysis. Preconditioning in this context refers to the reduction in biomass size and structure (e.g., mechanical breakdown with or without evaporation), which does not substantially affect the lignin, cellulose and hemicellulose compositions of the biomass. Preconditioning in this manner facilitates more efficient and economical processing of a downstream process (e.g., pyrolysis). Preferably, lignocellulosic biomass is debarked, chipped, shredded and/or dried to obtain preconditioned lignocellulosic biomass (also referred to as a conditioned lignocellulose preparation). Preconditioning of the lignocellulosic biomass can also utilize, for example, ultrasonic energy or hydrothermal treatments including water, heat, steam or pressurized steam. Preconditioning can occur or be deployed in various types of containers, reactors, pipes, flow through cells and the like. In some methods, it is preferred to have the lignocellulosic biomass preconditioned before pyrolysis. In some methods, depending on the biomass starting materials, no preconditioning is required e.g., lignocellulosic biomass can be directly taken into a pyrolysis step.

Optionally, lignocellulosic biomass can be milled or grinded to reduce particle size. In some embodiments, the lignocellulosic biomass is ground such that the average size of the particles is in the range of from 100 to 10,000 microns (e.g., 400 to 5,000 microns, 400 to 1,000 microns, 1,000 to 3,000 microns, 3,000 to 5,000 microns, or 5,000 to 10,000 microns). In some embodiments, the lignocellulosic biomass is ground such that the average size of the particles is less than 10,000, 9,000, 8,000, 7,000, 6,000, 5,000, 4,000, 3,000, 1,000, or 400 microns or within a range defined by any two of the aforementioned sizes. Ground particles from different lignocellulosic biomass materials can be processed by the same set of equipment using similar or same operating parameters. Reduced particle size can greatly accelerate the pyrolysis upgrading process.

Treatment of the Lignocellulosic Biomass Feedstock

In order to provide renewable feedstocks suitable for refinery operations, the lignocellulosic biomass feedstock is treated with a metal oxide catalyst on an oxide support under treating conditions to produce a treated stream comprising a liquid fraction comprising a bio-oil which has a total acid number of less than 100 mg KOH/g and, in some cases, much lower such as less than 30 mg KOH/g or even less than 10 mg KOH/g. The obtained bio-oil is particularly suitable as a renewable feedstock for hydroprocessing in biofuel manufacture.

Without being bound by theory, the treating is believed to proceed by a thermochemical process which includes one of more of cracking, decarboxylation, decarboxylation-coupling, dehydration and/or deoxygenation reactions.

Suitable treating conditions may comprise one or more of the following: a temperature in a range of from 400° C. to 600° C. (e.g., 450° C. to 550° C.); a pressure in a range of from 100 kPa to 10 MPa (e.g., 100 kPa to 3 MPa); and a weight hourly space velocity (WHSV) in a range of from 0.1 to 10 kg lignocellulosic biomass per kg metal oxide catalyst per hour (e.g., 0.5 to 5 kg lignocellulosic biomass per kg metal oxide catalyst per hour).

The reaction may be carried out in the presence of a carrier gas such as hydrogen, nitrogen, carbon dioxide, H₂O (water vapor) or C1-C4 hydrocarbons (e.g., methane, ethane, propane or mixtures thereof), preferably, CO₂ or H₂O. These gases may be admixed into the reaction mixture and/or may be formed in the course of the reaction. The carrier gas may be used to expel gaseous or volatile reaction products from the product mixture such as H₂O or CO₂.

The reaction is carried out in the presence of a basic metal oxide catalyst. The metal oxide catalyst comprises a metal oxide on an oxide support. The metal of the metal oxide may be selected from Na, K, Mg, Ca, Sr, Cr, Mo, Mn, Fe, Co, Ni, Cu, Zn, Al, rare earth metals, or a mixture thereof. Basic alkali and alkaline earth metals are preferred, particularly alkaline earth metals (e.g., Mg, Ca, Sr, Ba). The oxide support may be selected from alumina, silica, silica-alumina, titania, zirconia, or a mixture thereof. In some aspects, the metal oxide catalyst comprises CaO, the oxide support being alumina.

The metal oxide catalyst may include one or more matrix materials in an amount of from 30 wt. % to 60 wt. % based on the total weight of the catalyst. Representative matrix materials include clay materials such as kaolin.

The metal oxide catalyst may comprise from 15 wt. % to 60 wt. % inorganic filler based on the total weight of the catalyst. The inorganic filler may be alumina based. The inorganic filler may comprise one or more of aluminum biphosphate, alumina sol, activated alumina, a metal trapping agent, or combinations of these.

The metal oxide catalyst composition may be in the form of shaped microparticles, such as microspheres. The size of the microparticle refers to the maximum length of a particle from one side to another, measured along the longest distance of the microparticle. For example, a spherically shaped microparticle has a size equal to its diameter. The average particle diameter of the microspheres can range from 100 to 5000 microns (e.g., 500 to 3000 microns).

The bio-oil produced under the process described herein has a reduced acidity compared to a lignocellulosic-derived pyrolysis oil (“bio-oil”) conventionally produced from the same feedstock. Specifically, conventional bio-oil typically has a total acid number of greater than 150 mg KOH/g. The bio-oil produced under the present process has a total acid number of less than 100 mg KOH/g (e.g., less than 30 mg KOH/g, or less than 10 mg KOH/g). The total acid number can be determined using ASTM D664.

Preferably, the bio-oil produced by the process herein includes substantially no carboxylic acid, thus resulting in a reduced oxygen content. As the bio-oil produced herein has a reduced amount of oxygen, it has an increased heat value compared to a lignocellulosic-derived pyrolysis oil conventionally produced from the same feedstock.

As a result of its reduced total acid number and reduced acidity, the bio-oil produced by the process herein is substantially less corrosive than conventional lignocellulosic-derived pyrolysis oil.

The bio-oil produced herein may be processed further to produce a transportation fuel. Due to the significantly reduced oxygen content in the bio-oil of the present disclosure, the processing costs, particularly hydrogen costs for hydrogenation, are greatly reduced as compared to processing conventional pyrolysis oil for use as a transportation fuel.

The Reactor System

As described above, in order to provide renewable feedstocks of bio-oils suitable for refinery operations, the lignocellulosic biomass feedstock is treated with a metal oxide catalyst to produce a treated stream. The treated stream can be condensed and fractionated into a gas fraction and a liquid fraction, wherein the liquid fraction comprises water and a bio-oil suitable for use as a renewable feedstock for hydroprocessing. Example reactor systems for treating lignocellulosic biomass feedstocks will now be described in greater detail.

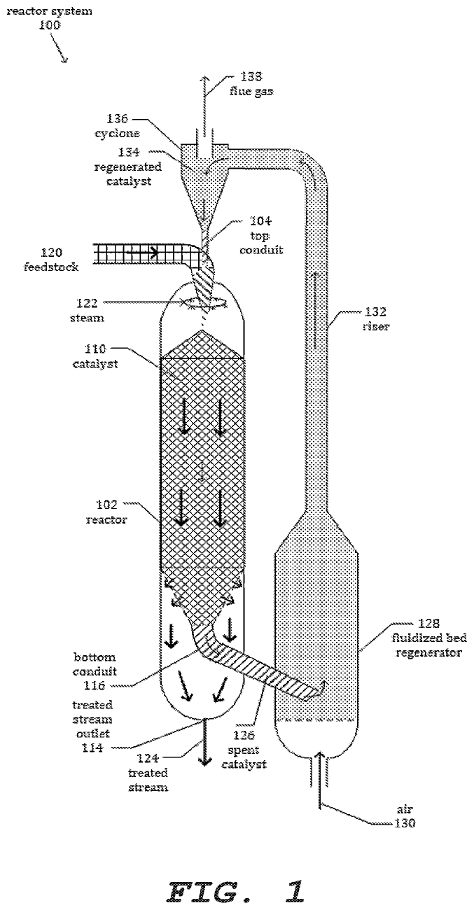

FIG. 1 illustrates one example reactor system in accordance with embodiments of the present disclosure. It should be understood that the example embodiments described herein can be applied to other types of reactor systems as well.

FIG. 1 illustrates certain components associated with a reactor system 100. Reactor system 100 can be used to treat a lignocellulosic biomass feedstock and produce a bio-oil renewable feedstock that is suitable for processing in a refinery for the ultimate production of transportation fuels. The reactor system 100 comprises a reactor 102 that is a concurrent downflow moving bed reactor and that is fluidly coupled to a fluidized bed regenerator 128. A moving bed reactor can be advantageous in that it reduces the likelihood of clogging of the components within the reactor. The reactor bottom is coupled to a bottom of the fluidized bed regenerator 128 by a bottom conduit 116. The fluidized bed regenerator 128 has a top that is coupled to a bottom of a cyclone 136, such as a pneumatic transport riser. A top conduit 104 connects a top of the riser 132 to a top of the reactor 102.

Further details will now be described in connection with the operation of the reactor system 100. A lignocellulosic biomass feedstock 120 is directed into the moving bed reactor 102 at a feedstock inlet. In one example as illustrated in FIG. 1, the lignocellulosic biomass feedstock inlet can be located at the top of the moving bed reactor 102 and the lignocellulosic biomass feedstock 120 can be mixed with freshly regenerated metal oxide catalyst 134 at the inlet to the reactor. The mixing of the regenerated metal oxide catalyst and the solid feedstock may optionally be improved by a static mixer located where the regenerated metal oxide catalyst and feedstock enters the reactor 102.

In the configuration shown in FIG. 1, steam 122 is injected into the top of the reactor 102, optionally through a flow distribution device such as a sparger as shown in FIG. 1 or a distribution tray or another distribution device and flows with the process stream down through the catalyst 110 and exits the reactor as part of the treated stream 124 through the treated steam outlet 114. Alternatively, the lignocellulosic biomass feedstock 120 can be mixed with a steam stream prior to entering the reactor 102 through the lignocellulosic biomass feedstock inlet. Optionally, the steam may be superheated to provide additional energy to the reactor. As representative examples, the lignocellulosic biomass feedstock flows into the moving bed reactor 102 at a rate of 1500 MTPD (62,500 kg/h), while the steam stream flows into the moving bed reactor 102 at a rate of 31,250 kg/h. The resulting process flow mixture flowing into the moving bed reactor is in a ratio of steam wt. % to biomass wt. % of 0.2 to 2 with a feed temperature of about 500° C. and a pressure of about 50 psig. The foregoing values for the feed rates, relative proportions, temperature, and pressure are simply representative examples and alternate embodiments encompass ranges of plus or minus 50% of these values.

The moving bed reactor 102 is typically generally cylindrical in shape and can have various dimensions. The representative example of a cylindrical reactor 102 in FIG. 1 can have an inner diameter of 2.6 meters in width, a height of 12.5 meters, a volume of 66 Nm³, and differential pressure between the top and bottom of the reactor of 1 to 50 psi. As a concurrent downflow moving bed reactor 102, the lignocellulosic biomass feedstock (mixed with steam) and the metal oxide catalyst 110 flow in a downward direction toward the bottom of the reactor as they are mixed and react under the treating conditions within the reactor 102. Representative ranges for the treating conditions within the reactor 102 are: a temperature in the range of 400° C. to 600° C., a pressure in the range of 100 kPa to 10 MPa, and a weight hourly space velocity in a range of 0.1 to 10 kg lignocellulosic biomass per kg catalyst per hour. The metal oxide catalyst typically will move in a downward direction through the reactor with a typical metal oxide catalyst residence time of 0.5 to 5 hours within the reactor 102, however, in other example embodiments the metal oxide catalyst residence time can range from 10 minutes to 24 hours. When referencing the metal oxide catalyst 110 in connection with the moving bed reactor 102 of FIG. 1, it should be understood that includes an oxide support. Examples of metal oxides and the oxide support for the catalyst were provided above in the description of the treatment of the lignocellulosic biomass feedstock. The metal oxide catalyst within the reactor typically has a packed density in the range of 400 to 1000 kg/m³. The catalyst particles are typically spherical or spheroid in shape having a diameter ranging from 100 to 5000 microns.

As the mixture of the lignocellulosic biomass feedstock 120 and the metal oxide catalyst 110 move downward through the reactor, the lignocellulosic biomass feedstock 120 is treated resulting in a treated stream 124 that exits the reactor at treated stream outlet 114. As provided above in the description of the lignocellulosic biomass feedstock treatment, the reaction with the metal oxide catalyst results in a treated stream that has a lower content of oxygen and impurities relative to the lignocellulosic biomass feedstock 120 that entered the reactor 102 and a total acid number of less than 100 mg KOH/g and typically less than 30 mg KOH/g and sometimes even less than 10 gm KOH/g. As representative values, the treated stream 124 can exit the moving bed reactor 102 at a pressure of about 50 psig and a temperature of about 485° C.

As the metal oxide catalyst 110 continues moving towards the bottom of the moving bed reactor 102 it can be referred to as spent metal oxide catalyst because it becomes coated with coke and mixed with particles of impurities, such as metal impurities, phosphorus, and chloride, that were present in the lignocellulosic biomass feedstock 120. An advantage of the continuous movement of the two streams within the moving bed reactor is that the presence of coke and impurities is less likely to clog the reactor. The spent metal oxide catalyst 126 is directed out of a spent catalyst outlet near the bottom of the moving bed reactor 102 and proceeds through bottom conduit 116 to the fluidized bed regenerator 128. A representative temperature for the spent metal oxide catalyst 126 exiting the moving bed reactor 102 is about 500° C.

The fluidized bed regenerator 128 is typically cylindrical in shape. It may be smaller or bigger in scale than the moving bed reactor 102. The fluidized bed regenerator 128 includes an air inlet through which a flow of air 130 enters for combustion within the regenerator. As one example, the air flow 130 can be at a rate of about 500 m³/h. As the spent metal oxide catalyst flows through the fluidized bed regenerator 128 coke on the catalyst is removed by combustion. As one example, the metal oxide catalyst can flow through the fluidized bed regenerator 128 at a circulation rate of 50,000 kg/h. Combustion within the fluidized bed regenerator 128 burns the coke off the catalyst returning the spent metal oxide catalyst to a metal oxide catalyst that can be used again in the moving bed reactor 102. In certain example embodiments, fuel can be added to the air flow 130 to increase the combustion within the fluidized bed regenerator 128 and add heat to the metal oxide catalyst.

The metal oxide catalyst that has been regenerated flows upward through a riser 132 attached to the top of the fluidized bed regenerator 128. The riser 132 can be a pneumatic transport riser. At the top of the riser 132, a cyclone 136 can separate the metal oxide catalyst from the flue gas and direct the flue gas out of the reactor system 100 through a flue gas outlet 138. The motion of the fluidized bed regenerator also assists in separating particles of impurities from the regenerated metal oxide catalyst. The cyclone 136 can direct the particles of impurities out of the reactor system 100 through the flue gas outlet 138 as well.

The metal oxide catalyst that has been regenerated in the fluidized bed regenerator flows from the riser 132, through the cyclone 136, and through the top conduit 104 where it reenters the top of the moving bed reactor 102 together with the lignocellulosic biomass feedstock 120. The metal oxide catalyst 110 then continues the treatment of new lignocellulosic biomass feedstock that enters the reactor 102 as both flow in a downward direction. It can be beneficial to the treatment conditions within the reactor 102 if the lignocellulosic biomass feedstock 120 enters the reactor 102 at a temperature that is below a reaction temperature. In order to raise the temperature of the lignocellulosic biomass feedstock 120 within the reactor, the metal oxide catalyst 110 that is returned to the reactor 102 from the fluidized bed regenerator 128 can contribute heat to the lignocellulosic biomass feedstock 120. As one example, the lignocellulosic biomass feedstock 120 can enter the moving bed reactor 102 at a temperature of about 500° C. and the metal oxide catalyst 110 from the fluidized bed regenerator 128 can enter the moving bed reactor 102 at a temperature of about 650° C. Thus, the metal oxide catalyst 110 can raise the temperature of the lignocellulosic biomass feedstock 120 to a reaction temperature within the moving bed reactor 102. If needed, the temperature of the metal oxide catalyst can be increased when it is in the fluidized bed regenerator 128 by adding fuel to the air flow 130 entering the fluidized bed regenerator 128.

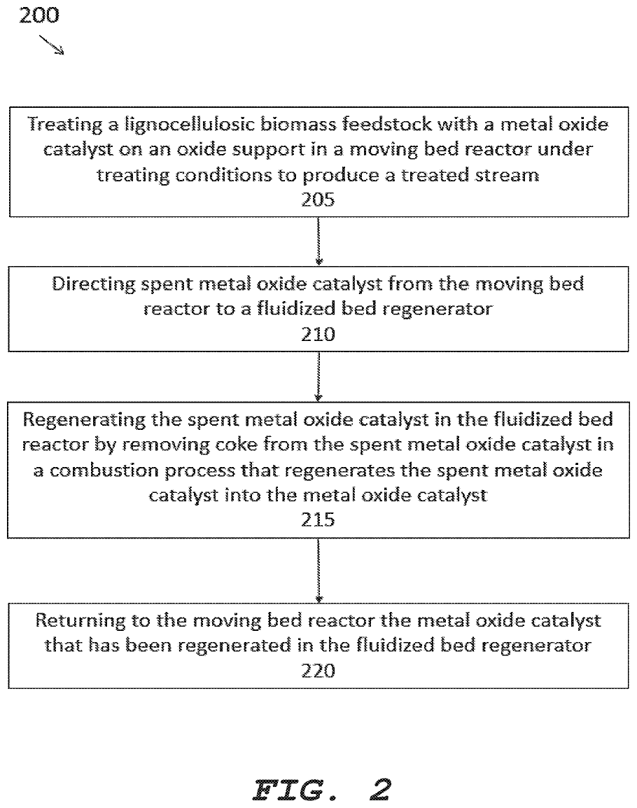

Referring now to FIG. 2, an example process 200 for operation of a reactor system is illustrated. The operations of example process 200 can correspond to the example reactor system 100 of FIG. 1 or to a different example reactor system within the scope of this disclosure. The operations of example process 200 are simply examples and in other embodiments the operations of process 200 can be modified.

Referring to operation 205 of process 200, a lignocellulosic biomass feedstock is treated with a metal oxide catalyst (which includes an oxide support) with a moving bed reactor. Treating conditions within the moving bed reactor, such as those treating conditions described previously, produce a treated stream. The treated stream can be removed from the moving bed reactor and condensed to obtain a bio-oil renewable feedstock that is suitable for refining into a transportation fuel.

In operation 210, spent metal oxide catalyst resulting from the treating of the lignocellulosic biomass feedstock is directed from the moving bed reactor to a fluidized bed regenerator. The spent metal oxide catalyst may contain coke deposits from the treating process and may be mixed with particles of impurities that were present in the lignocellulosic biomass feedstock. A moving bed reactor minimizes the likelihood that the coke deposits and the particles of impurities will cause clogging of the reactor.

In operation 215, the spent metal oxide catalyst is regenerated by a combustion process in the fluidized bed regenerator that burns the coke off the catalyst. Air and fuel can be introduced into the fluidized bed regenerator to enhance the combustion process and increase the heat of the metal oxide catalyst. The motion within the fluidized bed regenerator also can assist with separating particles of impurities from the metal oxide catalyst.

In operation 220, metal oxide catalyst resulting from the regenerating process in the fluidized bed regenerator is returned to the moving bed reactor where it can be used again to treat additional lignocellulosic biomass feedstock. Heating of the metal oxide catalyst from the combustion process in the fluidized bed regenerator can contribute beneficial heat to the lignocellulosic biomass when the two are mixed in the moving bed reactor.

Hydroprocessing

Beneficially, the bio-oil produced by the process disclosed herein may be used directly as a refinery feedstock.

The obtained bio-oil may be blended with one or more mineral oil feedstocks originating from crude oil, shale oil or coal and likewise used as a refinery feedstock. The bio-oil obtained as described herein may also be blended with renewable oils (e.g., oils made from lipids, such as renewable diesel, and synthetic renewable oils and waxes made from syngas by Fischer-Tropsch processes).

If desired, the bio-oil may be subjected to a catalytic hydroprocessing step. The obtained at least one effluent (hydroprocessing product) may be fractionated in a fractionating step to provide hydrocarbon fractions, suitable as renewable fuels or fuel components, useful as transportation fuels, fuel components, base oil and other chemicals.

The catalytic hydroprocessing step may be carried out in one step or in more than one steps.

The catalytic hydroprocessing step may be carried out by processing one or more fractions (such as distillation cuts) of the bio-oil separately or the bio-oil may be processed as a whole.

The catalytic hydroprocessing may comprise at least a hydrodeoxygenation step. Catalytic hydroprocessing may comprise a hydrodeoxygenation step followed by one or more steps selected from hydroisomerization and hydrocracking steps.

Hydroprocessing may be performed using one or more hydroprocessing catalysts comprising one or more metals selected from Group VIA and Group VIII metals. Particularly useful examples are Mo, W, Co, Ni, Pt and Pd. The catalyst(s) can also contain one or more support materials, for example zeolite, alumina, alumina-silica, zirconia, alumina-silica-zeolite and activated carbon. Suitably a mixture of CoO and MoO₃ (CoMo) and/or a mixture of NiO and MoO₃ (NiMo), and/or a mixture of Ni, Mo and Co and/or NiW and one or more support materials selected from zeolite, alumina, silica, zeolite-alumina, alumina-silica, alumina-silica-zeolite and activated carbon. Also, noble metals, such as Pt and/or Pd dispersed on alumina may be used.

Hydroprocessing conditions can include a temperature of from 100° C. to 450° C. (e.g., 200° C. to 370° C., or 230° C. to 350° C.); a pressure of from 0.5 to 30 MPa (e.g., 3 to 25 MPa, or 3 to 12 MPa); a weight hourly space velocity of from 0.01 to 10 kg lignocellulosic biomass per kg metal oxide catalyst per hour (e.g., 0.1 to 5 kg lignocellulosic biomass per kg metal oxide catalyst per hour). The hydrogen gas treat rate can be in a range of from 600 to 4000 Nm³/m³ (e.g., 1300 to 2200 Nm³/m³).

The hydroprocessing occurs in a reaction stage. The reaction stage can comprise one or more reactors or reaction zones each of which comprises one or more catalyst beds of the same or different catalyst. Although other types of catalyst beds/reactors can be used, fixed beds are preferred. Such other types of catalyst beds include fluidized beds, ebullating beds, slurry beds, and moving beds. Interstage cooling or heating between reactors, reaction zones, or between catalyst beds in the same reactor, can be employed.

At least one effluent from the hydroprocessing is drawn off from the last reactor. In one embodiment, the effluent is directed to a separator, such as any suitable separator or flashing unit. In the separator, typically water, gaseous stream comprising hydrogen, light hydrocarbons (e.g., C1 to C5 hydrocarbons), H₂S, CO and CO₂ are separated from the liquid component comprising >C5 hydrocarbons and some C1-C5 hydrocarbons. Water and gases may also be separated by other means which are well known to those skilled in the art.

The liquid hydrocarbon stream obtained from the hydroprocessing step includes fuel grade hydrocarbons having a boiling point of at most 380° C., according to ISO EN 3405. The person skilled in the art is able to vary the distilling conditions and to change the temperature cut point as desired to obtain any suitable hydrocarbon product, boiling suitably in the transportation fuel ranges.

1. A process comprising:
treating a lignocellulosic biomass feedstock in a moving bed reactor with a metal oxide catalyst on an oxide support under treating conditions to produce a treated stream, wherein the treating conditions in the moving bed reactor include a temperature in a range of from 400° C. to 600° C., a pressure in a range from 100 kPa to 10 MPa, and a weight hourly space velocity in a range from 0.1 to 10 kg lignocellulosic biomass per kg metal oxide catalyst per hour;
directing spent metal oxide catalyst from the moving bed reactor to a fluidized bed regenerator, the spent metal oxide catalyst resulting from treating the lignocellulosic biomass feedstock with the metal oxide catalyst;
regenerating the spent metal oxide catalyst in the fluidized bed regenerator by removing coke from the spent metal oxide catalyst in a combustion process that regenerates the spent metal oxide catalyst into the metal oxide catalyst; and
returning to the moving bed reactor the metal oxide catalyst that has been regenerated in the fluidized bed regenerator.

2. The process of claim 1, wherein the moving bed reactor is a concurrent downflow reactor in which the lignocellulosic biomass feedstock and the metal oxide catalyst flow from a top of the moving bed reactor to a bottom of the moving bed reactor.

3. The process of claim 2, wherein the combustion process in the fluidized bed regenerator adds heat to the metal oxide catalyst that is returned to the moving bed reactor.

4. The process of claim 3, wherein the lignocellulosic biomass feedstock is at a temperature that is below a reaction temperature when mixed with the metal oxide catalyst and wherein the metal oxide catalyst that is returned to the moving bed reactor from the fluidized bed regenerator raises the temperature of the lignocellulosic biomass feedstock to at least the reaction temperature.

5. The process of claim 1, wherein the lignocellulosic biomass feedstock is converted to a gaseous stream when mixed with the metal oxide catalyst.

6. The process of claim 1, further comprising mixing the lignocellulosic biomass feedstock with the metal oxide catalyst in a top conduit before the metal oxide catalyst enters a top of the moving bed reactor.

7. The process of 6, wherein the mixing is facilitated by a static mixer.

8. The process of claim 1, further comprising injecting steam directing a top of the moving bed reactor or with the metal oxide catalyst or with the lignocellulosic biomass feedstock.

9. The process of claim 8, wherein the steam is superheated.

10. The process of claim 1, further comprising preheating the lignocellulosic biomass feedstock to a temperature that is below a reaction temperature prior to directing the lignocellulosic biomass feedstock into the moving bed reactor.

11. The process of claim 1, further comprising fractionating the treated stream after it leaves the moving bed reactor to obtain a gaseous fraction and a liquid fraction, wherein the liquid fraction comprises a bio-oil having a total acid number of less than 100 mg KOH/g, as determined by ASTM D664.

12. The process of claim 11, further comprising subjecting the bio-oil to catalytic hydroprocessing in the presence of hydrogen to yield a hydroprocessing product comprising hydrocarbons boiling in the range of 40° C. to 380° C.

13. The process of claim 12, wherein the catalytic hydroprocessing comprises at least a hydrodeoxygenation step.

14. The process of claim 12, wherein the catalytic hydroprocessing comprises at least a hydrodeoxygenation step followed by one or more steps selected from hydroisomerization and hydrocracking steps.

15. The process of claim 12, further comprising mixing the bio-oil with a mineral oil feedstock to produce a mixture.

16. The process of claim 15, further comprising subjecting the mixture to catalytic hydroprocessing in the presence of hydrogen to yield a hydroprocessing product comprising hydrocarbons boiling in the range of 40° C. to 380° C.
